(19) United States
(12) Patent Application Publication
(10) Pub. No.: US 2011/0089853 A1
(43) Pub. Date: Apr. 21, 2011

(54) ELECTRONIC DRIVER APPARATUS FOR LARGE AREA SOLID-STATE LEDS

(75) Inventors: Deeder Aurongzeb, Mayfield Heights, OH (US); Bruce Richard Roberts, Mentor-on-the-Lake, OH (US)

(73) Assignee: General Electric Company

(21) Appl. No.: 12/581,120

(22) Filed: Oct. 17, 2009

(51) Int. Cl. H05B 37/00

(52) U.S. Cl. 315/290

(57) ABSTRACT

An electronic driver apparatus is provided for driving power an organic LED, including a switchable inductance circuit and a controller to connect an inductance between a power source and the OLED during a startup period as power is first applied to the OLED.

### BACKGROUND OF THE DISCLOSURE

Lighting devices are used for illuminating buildings, roads, and in other area lighting applications, as well as in a variety of signage and optical display applications. Large area solid-state devices, such as organic light-emitting diodes (OLEDS), are becoming more popular for such lighting system applications. Commercial viability of these lighting devices depends on length of service-life, and thus it is desirable to improve the operating conditions of OLEDs and other large area solid-state lighting devices so as to extend the usable device lifetime. Moreover, series-connected OLEDs often suffer from individual elements not consistently illuminating during startup. Thus, there remains a need for improved OLED driver apparatus and techniques to control consistent illumination, flicker and to mitigate premature device degradation.

### SUMMARY OF THE DISCLOSURE

The present disclosure provides drivers and methods for powering OLEDs and other large area solid-state light sources in which an inductance may be selectively introduced in series with the light source load circuit to implement adaptive inductance control to attenuate excessive current during initial device powerup and/or to alleviate light flicker problems.

An electronic driver apparatus is provided which includes a power source, such as a DC source, along with a switchable inductance circuit having an inductance coupled between the power source and the large area solid-state light source. A switching circuit is provided with one or more switching devices to selectively bypass the inductance in a first state and to allow current to pass from the power source to the light source through the inductance in a second state. The driver also includes a control component or controller that maintains the switching device in the second state during all or a portion of a startup period as power is first applied to the light source. Some embodiments include a power switch coupled between the power source and the switchable inductance circuit, with the controller connecting the inductance in the power circuit before operating the power switch to apply power to the light source. In one embodiment, the controller bypasses the inductance a non-zero time after placing the power switch in the first state, and in other embodiments the controller bypasses the inductance according to a signal from a feedback circuit. The switchable inductance circuit in certain embodiments includes two or more inductances that are individually coupleable by the controller during the startup period. The controller, moreover, may be operative to selectively include the inductance(s) in the circuit during subsequent operation according to the feedback signal, such as to address sensed flicker conditions.

A method is provided for powering large area solid-state light sources, which includes coupling an inductance between a power source and at least one large area solid-state light source, providing current from the power source to the light source through the inductance, and bypassing the inductance after current is first provided to the light source. Some embodiments further include sensing an electrical condition of the light source and bypassing the inductance at least partially according to the sensed feedback condition after the current has reached steady state. The inductance in certain embodiments is bypassed a non-zero time after placing the power switch in the first state, and in other embodiments current is allowed to pass from the power source to the at least one large area solid-state light source through the inductance during operation of the light source at least partially according to the feedback signal.

### BRIEF DESCRIPTION OF THE DRAWINGS

One or more exemplary embodiments are set forth in the following detailed description and the drawings, in which:

FIG. 1 is a schematic diagram illustrating a driver apparatus for a large area solid-state light source including a switchable inductance circuit;

FIG. 2 is a schematic diagram illustrating a switchable inductance circuit with two separately controllable series inductances;

FIG. 3 is a schematic diagram illustrating an exemplary OLED driver apparatus with switchable inductance circuitry;

FIG. 4 is a graph showing startup current and voltage curves for an OLED driver with no adaptive inductance control;

FIG. 5 is a graph showing startup current and voltage curves for an OLED driver with adaptive inductance control to reduce excessive startup current levels; and

FIG. 6 is a flow diagram illustrating an exemplary method of powering large area solid-state light sources.

### DETAILED DESCRIPTION OF THE PREFERRED EMBODIMENTS

Referring now to the drawings, where like reference numerals are used to refer to like elements throughout, and wherein the various features are not necessarily drawn to scale, the present disclosure relates to electronic drivers and methods for powering large area solid-state light sources. The disclosed concepts may be employed in association with organic LED (OLED) light sources or other solid-state lighting devices having large cross-sectional areas.

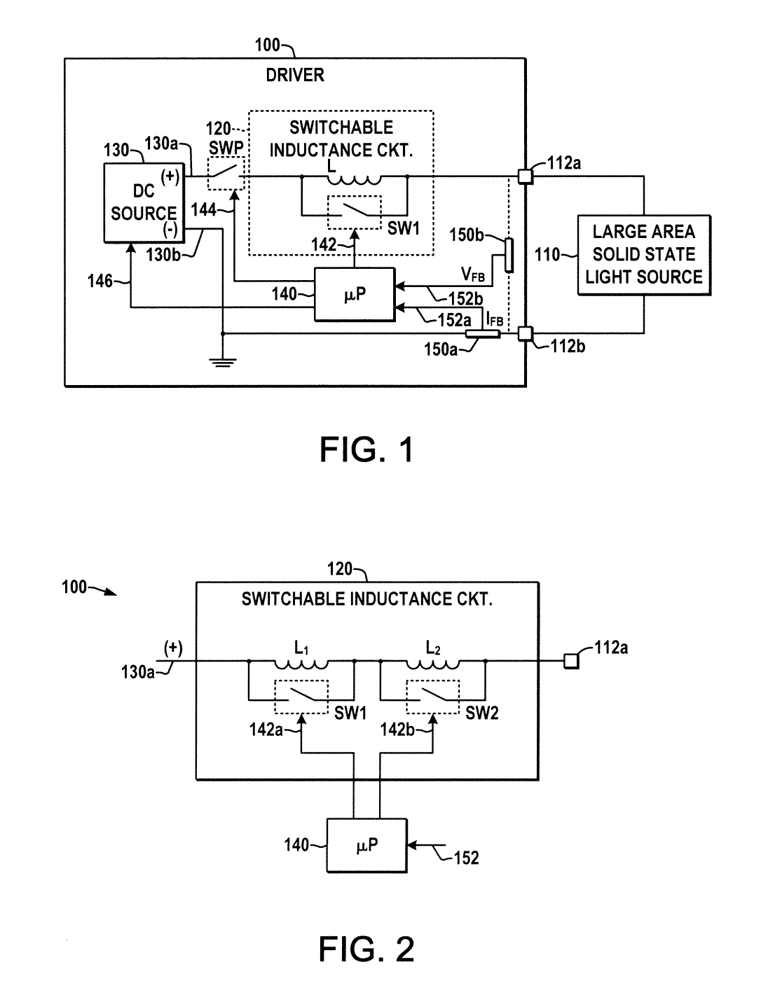

FIG. 1 depicts an electronic driver apparatus 100 with a power source 130 to provide electrical current for energizing one or more large solid-state light sources 110, such as OLED(s). Any suitable power source 130 may be employed in the driver 100, such as a DC source, which may be internally powered (e.g., via batteries, solar cells, etc.) or which may generate DC output power by conversion from an input supply (e.g., a rectifier converting input AC power from an external supply, not shown). The source 130 provides DC output voltage at output terminals 130a (+) and 130b (−) and is operative to supply DC current to a load coupled across the terminals 130a, 130b. The driver apparatus 100 further includes a switchable inductance circuit 120 and a control component 140 (e.g., microcontroller, microprocessor, logic circuit, etc.) which provide adaptive inductance control for advantageously mitigating degradation and/or reducing flicker of a driven light source 110. Output terminals 112a and 112b provide connections for a large area solid-state light source 110, such as one or more OLEDs for lighting applications when electrical current is provided by the driver 100.

The switchable inductance circuit 120 includes an inductance L coupled between the positive output terminal 130a of the power source 130 and the output terminal 112a, along with a switching circuit with a switching device SW1 coupled across the inductance L. The switching device SW1 is operative in a first (e.g., closed or ‘ON’) state to bypass the inductance L and in a second (e.g., open or ‘OFF’) state to allow current to flow through the inductance L from the power source 130 to the light source 110. The control component 140 provides a control signal 142 to operate the switch SW1. In operation of the illustrated embodiment, the controller 140 maintains the switching device SW1 in the second (open) state to allow current to pass from the power source 130 to the light source 110 through the inductance L during at least a portion of a startup period as power is first applied to the light source 110.

The illustrated driver apparatus 100, moreover, includes a power switch SWP coupled between the power source 130 and the switchable inductance circuit 120, which is operated via a control signal 144 from the controller 140. The power switch SWP is operable in a first ('ON') state to allow electrical current to flow from the power source 130 to the switchable inductance circuit 120, and in a second ('OFF') state to prevent current from flowing from the power source 130 to the switchable inductance circuit 120. The controller 140 may further provide one or more control signals/values 146 to control operation of the power source 130, such as current or voltage setpoints, reset signals, etc.

One or more feedback signals 152 may be generated by feedback circuitry 150 and provided to the controller 140 in certain embodiments. A first feedback circuit 150a (e.g., a shunt device) allows sensing of the load current flowing through the light source load 110, and provides a current feedback signal 152a (I_{FB}) to the controller 140. A second feedback circuit 150b senses the output voltage applied to the light source 110 across the terminals 112a, 112b and provides a voltage feedback signal 152b (V_{FB}) to the controller 140. The controller 140 can use one or both these feedback signals to infer or compute one or more aspects of the performance of the light source 110 and/or of the power source 130. In particular, the controller 140 can detect capacitance changes in an OLED type light source 110, flicker conditions, and/or excessive current levels using one or more of the feedback signals 152. In one embodiment, the controller 140 uses the feedback to sense or measure the capacitance of the load 110 and selectively allows current flow through the switchable series inductance L as required using the control signal 142.

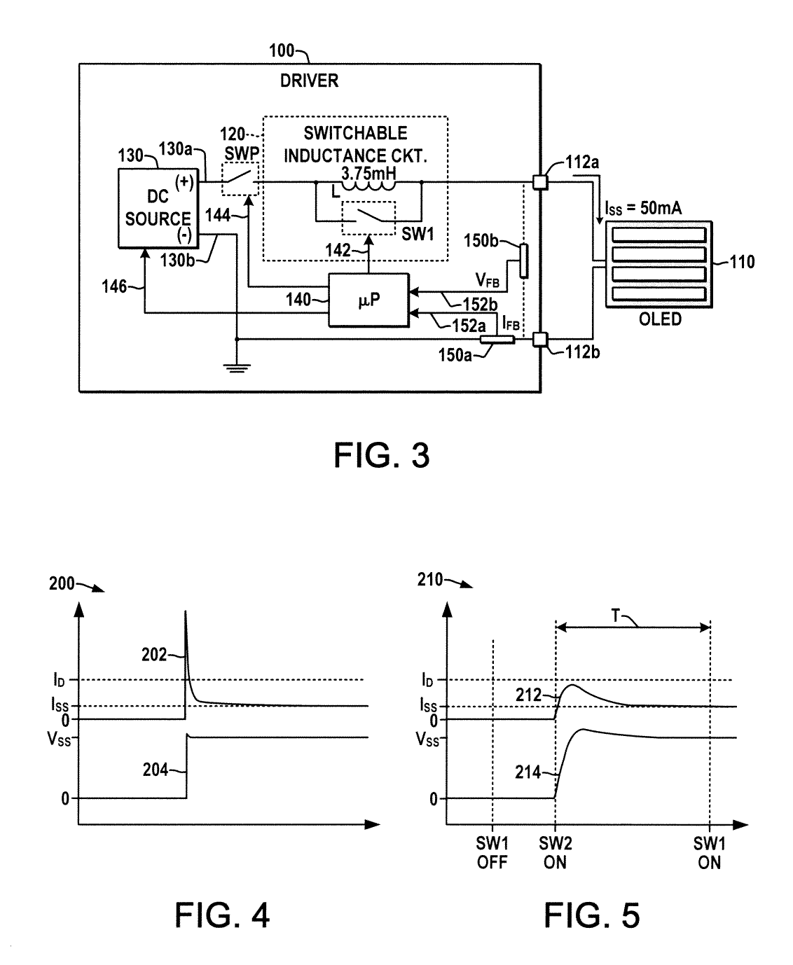

FIG. 3 illustrates an embodiment of the driver apparatus 100 operatively coupled to drive an OLED load 110 at a nominal operating current level I_{SS} of about 50 mA, and includes a switchable/bypassable inductance L of about 3.75 mH. Other inductance values L can be tailored to a desired startup current profile based on the capacitance of the OLED 110 (including compensation for capacitance/applied-voltage characteristics of a given OLED 110), the desired operating current level I_{SS}, a known or assumed degradation/stress current level I_{D}, and/or other design factors for a given implementation. In one example, the inductance L can be set to about 0.15 uH/cm² or more of a capacitive OLED device 110 operated at 15 V. In another example, the inductance L can be set to about 0.5 mH/uF of the OLED capacitance operating at 15 V.

In operation during a startup period, the controller 140 generates the control signals 142 and 144 so as to place the switching device SW1 in the second (open) state before placing the power switch SWP in the first (closed) state such that excessive startup current is limited. The inventors have appreciated that OLED type solid-state lighting devices are generally of substantial capacitance, and further that such devices 110 may be susceptible to excessive current surges during powerup. FIG. 4 illustrates a graph 200 showing startup current and voltage curves 202 and 204, respectively, for conditions in which the inductance L of the circuit 120 remains bypassed (e.g., switch SW1 open) during initial application of power via power switch SWP. As shown in FIG. 4, absent the adaptive inductance control features of the illustrated circuit 120 and controller 140, when the power source 130 is initially turned on, a high current surge may be experienced due to the capacitive load 110, which current may degrade the OLED 110 by dissociating the organic interface, leading to reduced operational lifetime or early device failure. For example, the current 202 may rise from zero to a high value well above the desired steady-state operating current level I_{SS}, and far in excess of a stress level I_{D} at which device degradation may begin.

Referring also to FIG. 5, to mitigate such premature degradation, the controller 140 selectively switches the inductance L in series with the capacitive load 110 to reduce the current surge. A graph 210 in FIG. 5 shows current and voltage curves 212 and 214, respectively, in the driver apparatus 100 during startup using the adaptive inductance components 120 and 140. In particular, at startup, the control component 140 in one embodiment generates the control signal 142 so as to insert the inductance L into the series load circuit (SW1 open) before activating the power switch SWP (via control signal 144). Once power is applied by closing the power switch SWP, the controller 140 in this embodiment places the switching device SW1 in the first state to bypass the inductance L a non-zero time T after placing the power switch SWP in the first state, as shown in FIG. 210. In this manner, the added inductance L dampens the current rise such that the curve 212 remains below the degradation stress level ID and eventually settles at the steady state value (e.g., about 50 mA in one example). Other inductance values L may be used to provide any amount of damping in consideration of tradeoffs between current overshoot and settling time requirements or specifications of a given application.

In another implementation, the driver apparatus 100 may use the feedback circuitry 150 to provide a feedback signal 152 indicative of an electrical condition (e.g., voltage, current, or value derived/inferred therefrom) to the controller 140, which selectively closes the switch SW1 (to bypass the inductance L) based at least partially on the feedback signal 152. For example, the controller may ascertain that the OLED current has settled to within a certain range around the steady state level I_{SS} and may then actuate the control signal 142 to close the switch SW1 thereby bypassing the inductance L.

The controller 140 and switchable inductance circuit 120 may also be operative after startup to control flicker or other changes in operation of the lighting device 110. For example, using the feedback signals 152, the controller 140 may be configured to sense the operating current (e.g., and to sense changes or fluctuations therein) and adapt the driver 100 by selectively introducing additional inductance into the circuit via control signal 142 at least partially according to the feedback signal(s) 152. In this manner, the controller 140 can adjust performance to mitigate light flickering conditions, to adjust for degraded output from the power source 130 (e.g., increased ripple current levels, etc.), or to accommodate degradation of the device 110 itself based on sensed changes in the load voltage and/or current.

Referring now to FIG. 2, another exemplary switchable inductance circuit 120 is shown with two separately controllable series inductances L1 and L2, which can be employed in the driver apparatus 100. Other implementations are possible using any number of inductances L and corresponding switching circuitry allowing the control component 140 to selectively couple or bypass inductances individually or in groups for adaptive control of the series inductance of the light source drive circuit. In the example of FIG. 2, the inductances L1 and L2 are coupled in series with one another between the power source 130 and the output terminal 112a, and the switching circuit has corresponding switching devices SW1 and SW2 individually operative via first and second switching control signals 142a and 142b from the controller 140 in a first (closed) state to bypass the associated inductance and in a second (open) state to allow current to pass from the power source 130 to the output terminal 112a through the corresponding inductance. The controller 140 in some embodiments may selectively use one or the other of the inductances L1, L2 in different configurable applications for driving different device loads 110 (e.g., L1 value tailored for driving a first OLED 110, and L2 value tailored for driving a second OLED 110). In other embodiments, multiple series and/or parallel connected inductances L can be disposed between the power source 130 and the output terminal 112a (and/or in the return path of the driver 100) with suitable switchable interconnections operable by the controller 140 to implement any desired adaptive inductance control to tailor operation of the apparatus 100 in startup and/or steady state operation.

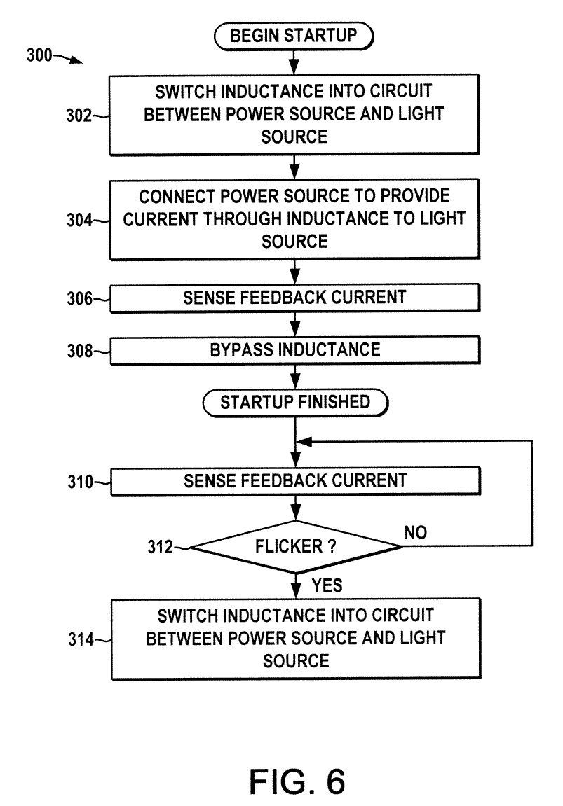

Referring also to FIG. 6, an exemplary method 300 is illustrated for powering one or more large area solid-state light source 110. The method 300 includes coupling an inductance L between a power source and light source 110 at 302 and providing current at 304 from the power source 130 to the light source 110 through the inductance L. One or more feedback values may be sensed at 306, such as the device current I_{FB}, and the inductance L is bypassed at 308 after the initial application of current to the light source 110. In one embodiment, the inductance L is bypassed at 308 at least partially according to the feedback condition sensed at 306. In other implementations, the bypass may be done at a given time (e.g., non-zero time ‘T’ in FIG. 5 above) after application of power at 304. After startup, the method 300 may further include sensing current or other feedback value at 310 and selectively inserting the inductance L back into the circuit at 314 (e.g., opening SW1 in FIGS. 1 and 3 above) during operation of the light source 110 at least partially according to the feedback signal 152, for example, to address detected flicker conditions determined at 312, etc.

The above examples are merely illustrative of several possible embodiments of various aspects of the present disclosure, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (i.e., that is functionally equivalent), even though not structurally equivalent to the disclosed structure which performs the function in the illustrated implementations of the disclosure. In addition, although a particular feature of the disclosure may have been illustrated and/or described with respect to only one of several implementations, such feature may be combined with one or more other features of the other implementations as may be desired and advantageous for any given or particular application. Furthermore, references to singular components or items are intended, unless otherwise specified, to encompass two or more such components or items. Also, to the extent that the terms “including”, “includes”, “having”, “has”, “with”, or variants thereof are used in the detailed description and/or in the claims, such terms are intended to be inclusive in a manner similar to the term “comprising”. The invention has been described with reference to the preferred embodiments. Obviously, modifications and alterations will occur to others upon reading and understanding the preceding detailed description. It is intended that the invention be construed as including all such modifications and alterations.

The following is claimed:

1. An electronic driver apparatus, comprising:
a power source operative to provide electrical current to power at least one large area solid-state light source;
a switchable inductance circuit including an inductance coupled between the power source and the at least one large area solid-state light source and a switching circuit with at least one switching device operative in a first state to bypass the inductance and in a second state to allow current to pass from the power source to the at least one large area solid-state light source through the inductance; and
a control component operatively coupled with the at least one switching device to maintain the at least one switching device in the second state to allow current to pass from the power source to the at least one large area solid-state light source through the inductance during at least a portion of a startup period as power is first applied to the at least one large area solid-state light source.

2. The driver apparatus of claim 1, where the power source is a DC power source operative to provide DC electrical current to power the at least one large area solid-state light source.

3. The driver apparatus of claim 1, further comprising a power switch coupled between the power source and the switchable inductance circuit, the power switch operable in a first state to allow electrical current to flow from the power source to the switchable inductance circuit and in a second state to prevent current from flowing from the power source to the switchable inductance circuit, where the control component is operatively coupled with the power switch and operable in the startup period to place the at least one switching device in the second state before placing the power switch in the first state to first apply power to the at least one large area solid-state light source.

4. The driver apparatus of claim 3, where the control component is operative to place the at least one switching device in the first state to bypass the inductance a non-zero time after placing the power switch in the first state.

5. The driver apparatus of claim 3, further comprising a feedback circuit providing a feedback signal indicative of an electrical condition of the at least one large area solid-state light source to the control component, where the control component is operative to place the at least one switching device in the first state to bypass the inductance a after placing the power switch in the first state at least partially according to the feedback signal.

6. The driver apparatus of claim 1, where the switchable inductance circuit includes a plurality of inductances coupled in series with one another between the power source and the at least one large area solid-state light source, where the switching circuit comprises a corresponding plurality of switching devices individually operative in a first state to bypass a corresponding one of the inductances and in a second state to allow current to pass from the power source to the at least one large area solid-state light source through the corresponding one of the inductances, and where the control component is operative to maintain at least one of the switching devices in the second state to allow current to pass from the power source to the at least one large area solid-state light source through the corresponding one of the inductances during at least a portion of the startup period as power is first applied to the at least one large area solid-state light source.

7. The driver apparatus of claim 6, further comprising a power switch coupled between the power source and the switchable inductance circuit, the power switch operable in a first state to allow electrical current to flow from the power source to the switchable inductance circuit and in a second state to prevent current from flowing from the power source to the switchable inductance circuit, where the control component is operatively coupled with the power switch and operable in the startup period to place at least one of the switching devices in the second state before placing the power switch in the first state to first apply power to the at least one large area solid-state light source.

8. The driver apparatus of claim 7, where the control component is operative to place at least one of the switching devices in the first state to bypass the corresponding one of the inductances a non-zero time after placing the power switch in the first state.

9. The driver apparatus of claim 7, further comprising a feedback circuit providing a feedback signal indicative of an electrical condition of the at least one large area solid-state light source to the control component, where the control component is operative to place at least one of the switching devices in the first state to bypass the corresponding one of the inductances after placing the power switch in the first state at least partially according to the feedback signal.

10. The driver apparatus of claim 1, further comprising a feedback circuit providing a feedback signal indicative of an electrical condition of the at least one large area solid-state light source to the control component, where the control component is operative to selectively place the at least one switching device in the second state to allow current to pass from the power source to the at least one large area solid-state light source through the inductance during operation of the at least one large area solid-state light source at least partially according to the feedback signal.

11. A method of powering at least one large area solid-state light source, the method comprising:
coupling an inductance between a power source and at least one large area solid-state light source;
providing current from the power source to the at least one large area solid-state light source through the inductance; and
bypassing the inductance after current is first provided to the at least one large area solid-state light source.

12. The method of claim 11, further comprising sensing an electrical condition of the at least one large area solid-state light source, and bypassing the inductance at least partially according to the sensed feedback condition.

13. The method of claim 11, where the inductance is bypassed a non-zero time after placing the power switch in the first state.

14. The method of claim 11, further comprising sensing an electrical condition of the at least one large area solid-state light source and selectively placing the at least one switching device in the second state to allow current to pass from the power source to the at least one large area solid-state light source through the inductance during operation of the at least one large area solid-state light source at least partially according to the feedback signal.

15. An electronic driver apparatus, comprising:
a power source operative to provide electrical current to power at least one large area solid-state light source;
a switchable inductance circuit including an inductance coupled between the power source and the at least one large area solid-state light source and a switching circuit with at least one switching device operative in a first state to bypass the inductance and in a second state to allow current to pass from the power source to the at least one large area solid-state light source through the inductance;
a feedback circuit providing a feedback signal indicative of an electrical condition of the at least one large area solid-state light source; and
a control component operatively coupled with the at least one switching device and with the feedback circuit to selectively place the at least one switching device in the second state to allow current to pass from the power source to the at least one large area solid-state light source through the inductance during operation of the at least one large area solid-state light source at least partially according to the feedback signal.
